(19) United States
(12) Patent Application Publication
(10) Pub. No.: US 2013/0002231 A1
(43) Pub. Date: Jan. 3, 2013

(54) ELECTROPHORETIC BREAKING RATE METER FOR ASPHALT EMULSIONS

(76) Inventors: Amit Bhasin, Austin, TX (US); Ambarish Banerjee, Austin, TX (US)

(21) Appl. No.: 13/540,376

(22) Filed: Jul. 2, 2012

Related U.S. Application Data
(60) Provisional application No. 61/503,706, filed on Jul. 1, 2011.

(51) Int. Cl. G01N 27/00

(52) U.S. Cl. 324/71.1

(57) ABSTRACT

Described herein is a device that can be used to measure the breaking rate and total breaking energy of an emulsion. Also described is a method of determining the breaking rate of an emulsion.

### PRIORITY CLAIM

This application claims priority to U.S. Provisional Patent Application No. 61/503,706 entitled “ELECTROPHORETIC BREAKING RATE METER FOR ASPHALT EMULSIONS” filed Jul. 1, 2011.

### BACKGROUND OF THE INVENTION

1. Field of the Invention

The invention generally relates to measuring devices. More particularly, the invention relates to devices for measuring the breaking rate of emulsions, particularly asphalt emulsions.

2. Description of the Relevant Art

Asphalt emulsions are composed of an asphalt binder or bitumen combined with an emulsifying agent dispersed in water. Asphalt emulsions are used in the surface treatment of pavements and to produce cold asphalt mixtures for pavement construction. The use of emulsions to produce cold mixtures is not as extensive as surface treatments. Asphalt emulsions are formulated to meet specific construction requirements (e.g., time available for curing, type of stone used, and weather conditions). A typical surface treatment involves spraying of the emulsion on the surface of the pavement, waiting for a short period of time to allow the emulsion to cure (evaporation of water), spraying a thin layer of aggregates or stones and allowing the emulsion to break (asphalt separates from the water and adheres to the aggregate surface) and cure (remaining water evaporates).

Asphalt emulsions are extensively used for surface treatments in several different countries. For example, in the year 2009 the state of Texas alone used approximately 100,000 tons of eight different types of asphalt emulsions for surface treatments. The increasing emphasis on maintaining and preserving our existing pavement infrastructure will continue to increase the demand for asphalt emulsions. The current practice to design surface treatments using asphalt emulsions is based on empirical test methods and is not based on fundamental material properties. More importantly, current specifications for asphalt emulsions are mostly related to the residue from the emulsion, i.e. the asphalt cement, and very few requirements are in place to ensure the quality of the emulsion by itself. This practice ensures that the asphalt binder used in the emulsion results in a surface treatment that has long-term durability. In fact, development of the specifications for the asphalt binder (residue from the emulsion) is a subject of ongoing research at the state and national level. However, since the properties of the emulsion by itself (asphalt binder+emulsifier+water) are typically not included in the specifications or QA/QC requirements, there is very little control on the constructability and short-term performance of the emulsion.

As mentioned above, the quality of the emulsion influences the quality of the surface treatment. For example, properties of the emulsion such as workability and the time to break from the instant the aggregates are placed may result in premature failure of the surface treatment. An emulsion with higher viscosity may not coat the aggregate surface adequately or an emulsion that is partially broken may not form adequate bonds with the aggregates. In addition, one of the primary reasons to use asphalt emulsion for surface treatment is the potential savings that results from minimal heating requirements. However, there is anecdotal evidence that suggests that asphalt emulsions break during transport and application. This requires raising the temperature of the transport tank or applicator to achieve the desired workability. These examples emphasize the need to specify and control the quality of the emulsion used for surface treatments.

Currently there is a need for a test method that can be deployed in the field to ensure that the quality of the emulsion supplied at the construction site is the same as the emulsion used to design the surface treatment or specified for use. Engineers at the field also need to know the breaking rate of the emulsion so that they can decide the time required before the placement of the aggregates over the sprayed emulsion or the time required before the site can be opened to traffic after placement of the aggregates. The current practice is to use experience and qualitative methods to estimate the time of placement and opening to traffic (e.g., using a Bowman's stick). An inexperienced engineer or poor judgment can have disastrous consequences.

### SUMMARY OF THE INVENTION

Described herein is a device that can be used in the field to measure the breaking rate and total breaking energy of the emulsion. This device can identify whether the emulsion is cationic or anionic, whether it is partially broken, or has significantly higher or lower viscosity than desired. Viscosity of the emulsion also provides an indirect estimate of the asphalt content in the emulsion.

In one embodiment, a device for determining the breaking rate of an emulsion comprises: a probe comprising an outer shell (which also serves as one of the electrodes) and an inner electrode concentrically positioned within the outer shell; a power source coupled to the probe; and a meter coupled to the power source, wherein the meter measures the current flowing from the power source through the electrodes during use. In some embodiments, the device may include a load cell coupled to the inner electrode, wherein the load cell measures the mass of the electrode during use. The device is particularly suited for determining the breaking rate of an asphalt emulsion.

In an embodiment, a method of determining the breaking rate of an emulsion comprises: placing a probe from a measuring device into the emulsion, wherein the probe comprises of two electrodes connected to the opposite polarities of a power source. The two electrodes are positioned concentrically. The circuit is connected to an electronic multimeter that measures the current flowing through the test probe and records the information into a handheld data acquisition system. In an embodiment, the potential difference maintained between the two electrodes can range between 10 V DC and 40 V DC. The current passing through the probe, in some embodiments, is measured until the current flow is about zero. The method may also include determining the increase in mass of the probe as the current passes through the probe. The method is particularly suited for determining the breaking rate of an asphalt emulsion.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 is a schematic diagram of a device for determining the breaking rate of an emulsion;

FIG. 2 depicts a graph of the current vs. time during a method of determining the breaking rate of an emulsion; and

FIG. 3 depicts the breaking energy of various asphalt emulsions determined using the disclosed device and method.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Two important material characteristics of an asphalt emulsion are its zeta potential and viscosity. Measurement of zeta potential requires a laboratory device that costs approximately $40,000 and cannot be used in the field. Viscosity of the emulsion can be measured using bench top laboratory equipment or other methods such as the shell cups in the field. The zeta potential and viscosity of the emulsion (related to the water content) influence the rate at which the emulsion breaks in the field.

In one embodiment, a portable device may be used to measure the breaking rate of asphalt emulsions in field (at a construction job site) and/or in a laboratory. The device uses electrokinetic techniques to measure the rate at which asphalt emulsions break. A portable version of this device can be used in the field for QA/QC of asphalt emulsions used in the construction and maintenance of roadways. A slightly modified version of this same instrument can also be used in the laboratory to obtain the breaking rate with a greater degree of accuracy. This device does not replace the devices used to measure the zeta potential or viscosity but provides a low cost and practical tool to measure the combined influence of these two properties on the breaking rate of emulsions. The device costs substantially less than the alternatives and can be used in the field for QA/QC measurements or in the laboratory to obtain the breaking characteristics of different emulsions to design surface treatments for the pavement.

In an embodiment, a device will break the emulsion by applying an electric potential across the emulsion and indirectly quantify the amount of breakage by measuring the current passing through the emulsion between the electrodes over time. In an embodiment, the device measures the current flow as a small sample of the emulsion breaks. The device further may record the current flow in real time as the breaking progresses and the base material (asphalt in this case) saturates one of the two electrodes. By using compact electrodes and recording the potential applied and current flow in real time, the device provides information on the breaking rate of the emulsion as well as the total breaking energy required to saturate the electrode. The total breaking energy is dependent on the type of emulsion and its viscosity. Therefore, this device and the information it produces can be used as quality check for the type of emulsion.

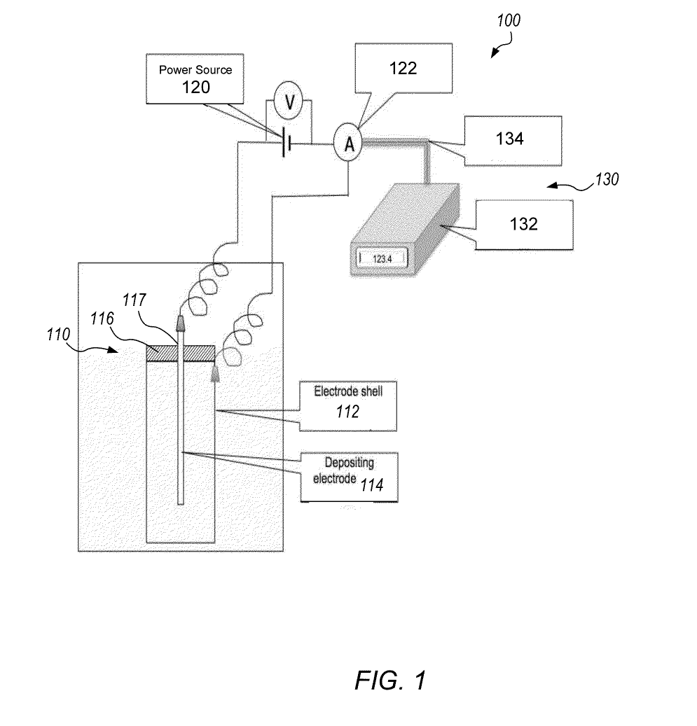

FIG. 1 depicts a schematic diagram of a device 100 used to measure the breaking rate of asphalt emulsions. The device has three main components: (i) a probe 110, (ii) a source of regulated direct current 120 coupled with an electronic multi meter 122 and (iii) a data acquisition system 130. In an alternate embodiment, a load cell may be coupled to one of the electrodes in the probe and the mass of the probe may also be recorded in real time.

Probe 110, in one embodiment, is constructed out of a conducting material (e.g., aluminum). Probe 110, in an embodiment, has an outer shell 112 that is about 25 mm in diameter. The second or depositing electrode 114 is a solid cylinder about 5 mm in diameter that is concentrically fixed to the outer shell using an insulating support 116 (e.g., composed of cork or rubber). For example, insulating support 116 include an opening 117 through which electrode 114 is inserted. Insulating support 116 has a diameter substantially equivalent to the diameter of outer shell 112 such that the insulating support is held in place by contact with the outer shell. In some embodiments, electrode 114 may be coupled to a strain gauge type load cell of 200 g capacity, allowing the material deposited on the probe to be weighed. Outer shell 112 and deposition electrode 114 are coupled to the positive and ground of the source of the electric current. The type of emulsion being tested dictates the choice of the connection. For anionic emulsions outer shell 112 is connected to the ground, whereas for cationic emulsions deposition electrode 114 is connected to the ground.

A source of direct current 120 capable of providing 0 to 40 V DC is used as the power source. Testing of asphalt emulsions may be conducted at a voltage ranging from 10 to 40 V DC. For QA/QC applications, it is recommended that the same voltage be used for all tests. The power source is connected to a USB digital multi-meter 122 having, in some embodiments, a data collection rate of greater than 10 points per second and resolution better than 10 micro amps for current and 10 millivolts for voltage. In some embodiments, USB digital multi-meter 122 may be a USB meter having a trigger switch.

Data acquisition system 130 may include a computer 132 (e.g., a laptop computer) or a portable hand held device compatible with the USB digital multi-meter and capable of recording data passed on by the digital multi-meter and performing simple mathematical operations in real time using a software or embedded system. Data acquisition system may include data communication line 134 coupling meter 122 to computer 132.

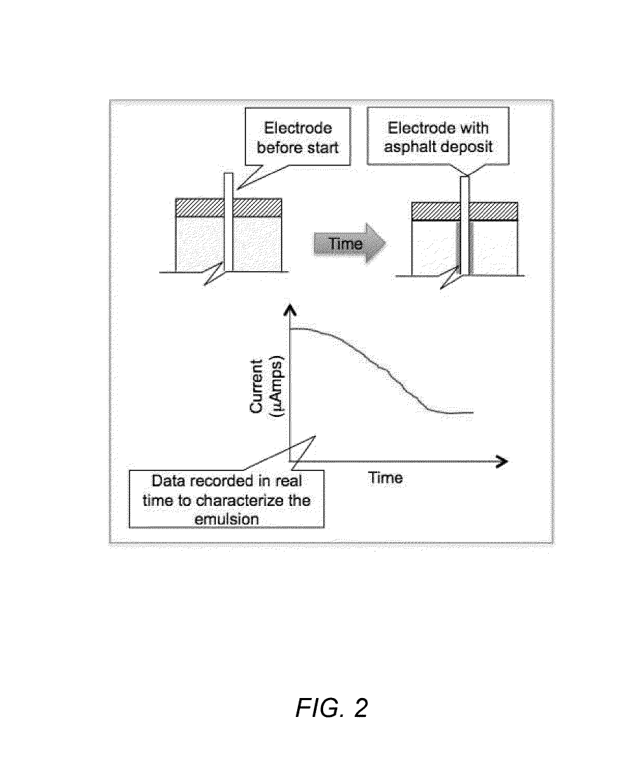

Probe 110 is wired through the USB digital multi-meter in series to record charge flow or current in real time. Typical tests are conducted at 20 V DC. The current is recorded as a function of time (FIG. 2) until the rate of change of current flow through the circuit is insignificant for a pre specified duration of time. The total amount of charge transacted during this process (integral of current with respect to time) is defined as the total breaking energy. The maximum current that passes through the circuit is defined as the maximum rate of charge flow. The time required to achieve 95% of the breaking energy is defined as the probe saturation time. The three parameters, total breaking energy, maximum rate of charge flow or maximum current and probe saturation time are dependent on the physio-chemical characteristics and condition of the emulsion (e.g. viscosity and partial breaking in the emulsion prior to test). These parameters are computed and recorded by data acquisition device 130 and reported to the user. The test can be conducted at the construction site and the quality of the emulsion can be compared to approved standards based on these parameters.

As can be seen, schematically, in FIG. 2, asphalt will deposit on probe 110 as the test is conducted. In an embodiment, a load cell may be coupled to the probe to record the mass of the asphalt deposited on the probe in real time. The rate of mass deposition along with the aforementioned parameters (total breaking energy, probe saturation time, and maximum rate of charge flow) can be used to obtain estimates for the physical properties of the emulsion and a direct measure of the breaking rate.

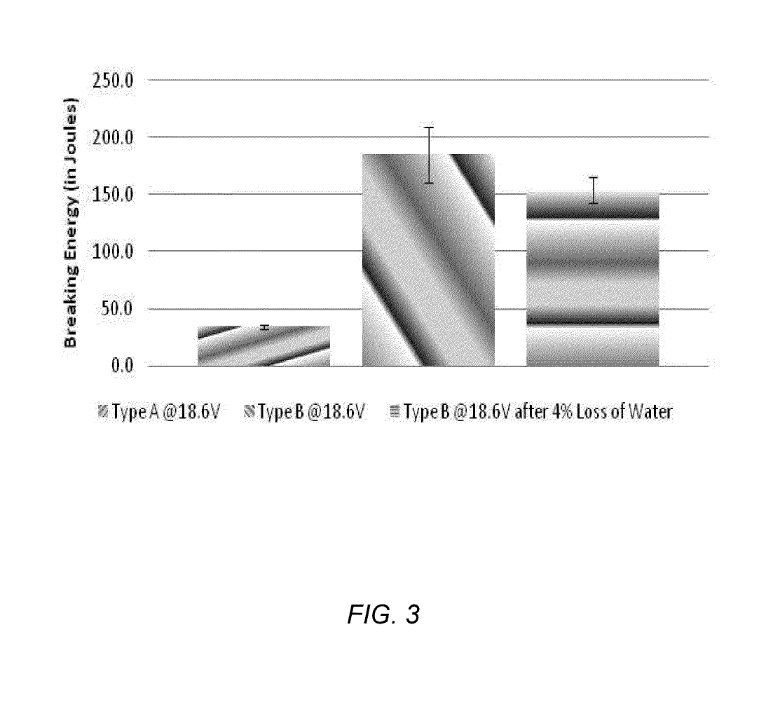

FIG. 3 illustrates the total breaking energy of two different types of emulsion as well as the total breaking energy of the first emulsion that was partially cured or broken prior to testing. Rapid setting or slow setting, cationic or anionic water based emulsions can be used with this test. In a typical test, approximately 50 ml of the emulsion is poured into the outer shell or electrode. Alternatively, the electrode assembly can be completely immersed in an electrically insulated container (e.g. glass) containing the emulsion. For cationic emulsions the shell and core electrodes are connected to the positive and negative terminals of the direct current voltage source, respectively. These connections are reversed for an anionic emulsion. The test is conducted at an ambient temperature or any other temperature that may be of interest for the application. After immersing the electrode assembly into the emulsion, power supply to the electrodes and the data acquisition are simultaneously switched on. This can be done manually or with the aid of a trigger switch. The current passing between the electrodes is recorded over time until the rate of change of current is negligible. In some embodiments, the mass deposited over the electrode is also measured over time. The rate of breaking and the total breaking energy are then computed from this data in terms of the rate of current flow and total charge flow (current integrated over time) to characterize the emulsion.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A device for determining the breaking rate of an emulsion, the device comprising:
a probe comprising an outer shell electrode and an inner electrode concentrically positioned within the outer shell electrode;
a power source coupled to the probe; and
a meter coupled to the power source, wherein the meter measures and records the current flowing from the power source through the electrodes during use.

2. The device of claim 1, further comprising an insulating support coupling the outer shell to the electrode.

3. The device of claim 1, wherein the power source provides 0 to 40 V DC power to the probe.

4. The device of claim 1, wherein the outer shell is coupled to the ground of the power source and the electrode is coupled to the positive terminal of the power source for an anionic emulsion.

5. The device of claim 1, wherein the outer shell is coupled to the positive terminal of the power source and the electrode is coupled to the ground of the power source for a cationic emulsion.

6. The device of claim 1, further comprising a load cell coupled to the inner electrode, wherein the load cell measures the mass of the electrode during use.

7. The device of claim 1, wherein the emulsion is an asphalt emulsion.

8. A method of determining the breaking rate of an emulsion, the method comprising:
placing a probe from a measuring device into the emulsion, wherein the probe comprises an outer shell electrode and an inner electrode concentrically positioned within the outer shell electrode;
sending power to the probe from a power source; and
measuring and recording the current passing through the probe as the emulsion breaks with a typical resolution of 10 micro amps or better and a typical time intervals of 100 milliseconds or better.

9. The method of claim 8, wherein the power provided is between about 10 V DC to about 40 V DC.

10. The method of claim 8, wherein the current passing through the probe is measured until the rate of change of current flow is about zero.

11. The method of claim 8, wherein the probe further comprises an insulating support coupling the outer shell to the electrode.

12. The method of claim 8, wherein the emulsion is an anionic asphalt emulsion, and wherein the outer shell is coupled to the ground of the power source and the electrode is coupled to the positive terminal of the power source.

13. The method of claim 8, wherein the emulsion is an cationic asphalt emulsion, and wherein the outer shell is coupled to the positive terminal of the power source and the electrode is coupled to the ground of the power source.

14. The method of claim 8, further comprising determining the increase in mass of the probe after measurement of the current passing through the probe is completed.

15. The method of claim 8, wherein the emulsion is an asphalt emulsion.
